(19) United States
(12) Patent Application Publication
(10) Pub. No.: US 2024/0095310 A1
(43) Pub. Date: Mar. 21, 2024

(54) INFORMATION PROCESSING DEVICE, DATA GENERATION METHOD, GROUPING MODEL GENERATION METHOD, GROUPING MODEL LEARNING METHOD, EMOTION ESTIMATION MODEL GENERATION METHOD, AND GROUPING USER INFORMATION GENERATION METHOD

(71) Applicant: SONY GROUP CORPORATION, Tokyo (JP)

(72) Inventors: Yasuhide HYODO, Tokyo (JP); Yuta KONDO, Tokyo (JP)

(73) Assignee: SONY GROUP CORPORATION, Tokyo (JP)

(21) Appl. No.: 18/254,953

(22) PCT Filed: Nov. 15, 2021
(86) PCT No.: PCT/JP2021/041866

§ 371 Date: May 30, 2023

(30) Foreign Application Priority Data
Dec. 7, 2020 (JP) 2020-202690

(51) Int. Cl. G06F 18/22

(52) U.S. Cl. CPC G06F 18/22; G06V 40/174

(57) ABSTRACT

To provide a technology capable of grouping users who have high compatibility with each other. An information processing device includes: one or more processors; and one or more memories storing instructions that, when executed by the one or more processors, cause the information processing device to execute operations, wherein the operations include grouping a plurality of users based on biological information of the plurality of users.

### TECHNICAL FIELD

The present technology provides an information processing device, a data generation method, a grouping model generation method, a grouping model learning method, an emotion estimation model generation method, and a grouping user information generation method.

### BACKGROUND ART

Matchmaking services to help people connect are used in various fields such as romance, marriage, employment, and business.

Several technologies for matchmaking have been proposed so far. For example, PTL 1 listed below describes a computer-implemented method for matchmaking in a virtual space. That method includes the steps of detecting input from a user based on movement of the user using a head-mounted device connectable to a computer, and matchmaking based on the detected input. PTL 2 listed below describes a matchmaking system that executes matchmaking planning processing using Individual Numbers. PTL 3 listed below describes a method and device for making a match between people based on pre-programmed preferences.

### CITATION LIST

### Patent Literature

PTL 1: JP 2018-106679A
PTL 2: JP 2017-59192A
PTL 3: JP 2009-541844T

### SUMMARY

### Technical Problem

Matchmaking services are required to improve the accuracy of matchmaking, that is, to improve the compatibility between users for which a match is made. The inventor(s) conceived that a technology capable of grouping users who have high compatibility with each other among a plurality of users who use a matchmaking service would be useful in order to improve the accuracy of matchmaking. This is because the grouping allows the matchmaking targets to be narrowed down, so that it is possible to accurately find users who have higher compatibility with each other.

Therefore, a main object of the present technology is to provide a technology capable of grouping users who have high compatibility with each other.

### Solution to Problem

Incidentally, compatibility between people is often judged based on emotions evoked through communication. Positive emotions evoked through communication, such as goodwill, respect, and pleasure, is likely to result in an impression that the communication partner has high compatibility with each other. Conversely, negative emotions evoked such as disgust, contempt, and displeasure is likely to result in an impression that the communication partner has low compatibility with each other. In this way, the compatibility with a specific person is correlated with the emotions evoked about that person during communication.

Emotions are emotional movements with biological reactions of the autonomic nervous system. When an emotion is evoked, a signal is transmitted from the brain through the autonomic nervous system, causing a change in the biological reaction of the autonomic nervous system, and as a result, changes appear in biological information such as pulse, heart rate, and brain wave. Various studies have been conducted on the correlation between biological information and emotions, and a large amount of knowledge regarding that correlation has been accumulated. In addition, with progress in biological information measurement and analysis technology, changes in biological information have been able to be measured more easily and accurately. Utilizing these studies and technologies, methods for estimating human emotions by using biological information have been proposed in recent years.

As a result of intensive studies aimed at solving the above problem, the inventor(s) focused on using biological information of users in order to group users who have high compatibility with each other. Specifically, the inventor(s) focused on the fact that changes in emotions that may affect the judgment of compatibility are correlated with biological information, and as a result, found that the use of biological information allows grouping of users who have high compatibility with each other, leading to the present technology.

Accordingly, the present technology provides an information processing device including:
one or more processors; and
one or more memories storing instructions that, when executed by the one or more processors, cause the information processing device to execute operations,
wherein the operations include
grouping a plurality of users based on biological information of the plurality of users.

The grouping of the plurality of users based on the biological information of the plurality of users may include grouping the plurality of users based on
the biological information of the plurality of users, and
at least one of: image information of faces of the plurality of users as subjects, sound information including speech voices of the plurality of users, and location information of the plurality of users.

The one or more memories may further store attribute information of the plurality of users, and the grouping of the plurality of users based on the biological information of the plurality of users may include grouping the plurality of users based on
the biological information of the plurality of users and the attribute information of the plurality of users.

The one or more memories may further store grouping history information that is a result of grouping the plurality of users in the past based on the attribute information of the plurality of users, and
the grouping of the plurality of users based on the biological information of the plurality of users may include grouping the plurality of users based on
the biological information of the plurality of users, the attribute information of the plurality of users, and the grouping history information for each piece of the attribute information.
   The grouping of the plurality of users based on the biological information of the plurality of users may include grouping the plurality of users based on
emotion estimation data generated using the biological information of the plurality of users.

The grouping of the plurality of users based on the biological information of the plurality of users may include grouping the plurality of users based on
emotion estimation data generated using the biological information of the plurality of users, and
at least one of: facial expression data generated using image information of faces of the plurality of users as subjects, speech data generated using sound information including speech voices of the plurality of users, and user-to-user distance data generated using location information of the plurality of users.

The emotion estimation data generated using the biological information of the plurality of users may be generated by
inputting the biological information of the plurality of users into an emotion estimation model generated in advance by machine learning using teacher data in which human biological information and human emotions are associated with each other.

The grouping of the plurality of users based on the biological information of the plurality of users may include
creating user pairs each composed of two users included in the plurality of users based on the biological information of the plurality of users.

The grouping of the plurality of users based on the biological information of the plurality of users may include grouping the plurality of users may include
calculating a plurality of matchmaking indices for a user pair composed of two users included in the plurality of users;
calculating a distance between the users of the user pair based on a matchmaking index vector of each user in a matchmaking space composed of the plurality of matchmaking indices;
calculating a degree of matchmaking between the users of the user pair by using the distance between the users in the matchmaking space; and
grouping the plurality of users by using the degree of matchmaking, and
the calculating of the plurality of matchmaking indices may include
calculating the matchmaking indices based on the biological information of users of the user pair.

The calculating of the matchmaking indices based on the biological information of the users of the user pair may include
performing in-phase/anti-phase analysis using time-series data of the biological information of the users of the user pair to calculate a first matchmaking index.

The calculating of the first matchmaking index may include
calculating the first matchmaking index by Equation (I):

r=f(t)*g(t−τ) (I)

(When the users of the user pair are user A and user B, in Equation (I), r indicates the first matchmaking index, f(t) indicates time-series data of biological information of user A at a certain time, g(t) indicates time-series data of biological information of user B at a certain time, and τ indicates a deviation of timing of a physiological index with respect to an external stimulus that takes positive and negative values.)

The calculating of the matchmaking indices based on the biological information of the users of the user pair may include
performing calculation of an index of absolute difference value using time-series data of the biological information of the users of the user pair to calculate a second matchmaking index.

The calculating of the degree of matchmaking between the users of the user pair by using the distance between the users in the matchmaking space may include
calculating the degree of matchmaking by Equation (III):

[Math. 1]

D_{w}(X_{personA},X_{personB})=\sqrt{Σⱼ₌₁^{N}wⱼ(X_{personA,j}−X_{personB,j})²} (III)

(When the users of the user pair are user A and user B, in Equation (III), D_{w}(X_{personA}, X_{personB}) indicates the degree of matchmaking, N indicates the number of dimensions of the matchmaking space, X_{personA} indicates a matchmaking index vector of user A, X_{personB} is a matchmaking index vector of user B, j indicates an element number of the matchmaking index vector, and w (w=w₁, w₂, . . . , w_{N}) indicates a weight vector preset for each matchmaking index.)

The operations may include performing
at least one of: processing for notifying the plurality of users of group information on a result of grouping the plurality of users and processing for prompting the plurality of users to act in a way that a physical distance between users in a same group becomes shorter.

The operations may include repeating:
grouping the plurality of users based on the biological information of the plurality of users; and at least one of: processing for notifying the plurality of users of group information on a result of grouping the plurality of users and processing for prompting the plurality of users to act in a way that a physical distance between users in a same group becomes shorter.

The operations may include
receiving feedback data from one or more users.

The grouping of the plurality of users based on the biological information of the plurality of users may be executed by artificial intelligence.

The emotion estimation data may be generated by artificial intelligence.

The plurality of users may be a plurality of users who each carry a biological information acquisition device, and

The biological information of the plurality of users may be biological information of the plurality of users acquired by the biological information acquisition devices.

Further, the present technology provides a data generation method executed by one or more processors, the data generation method including
generating group information on a result of grouping a plurality of users based on biological information of the plurality of users.

Further, the present technology provides a data generation method executed by one or more processors, the data generation method including
generating data in which group information on a result of grouping a plurality of users based on biological information of the plurality of users and a measurement condition of the biological information when the biological information is acquired are associated with each other.

Further, the present technology provides a grouping model generation method executed by one or more processors, the grouping model generation method including
by performing machine learning using teacher data in which biological information of a plurality of users and group information on a result of grouping the plurality of users based on the biological information of the plurality of users are associated with each other, generating a grouping model that outputs the group information in response to input of the biological information of the plurality of users.

Further, the present technology is a grouping model learning method executed by one or more processors, the grouping model learning method including
causing a grouping model generated by machine learning using teacher data in which biological information of a plurality of users and group information on a result of grouping the plurality of users based on the biological information of the plurality of users are associated with each other, to further learn teacher data in which the biological information, the group information, and feedback data from the users are associated with each other.

Further, the present technology provides an emotion estimation model generation method executed by one or more processors, the emotion estimation model generation method including by performing machine learning using teacher data in which human biological information and human emotions are associated with each other, generating an emotion estimation model that outputs emotion estimation data of a plurality of users used to group the plurality of users in response to input of biological information of the plurality of users.

Further, the present technology provides a grouping user information generation method executed by one or more processors, the grouping user information generation method including: aligning time axes of time-series data of biological information of a plurality of users; and outputting grouping user information used to group the plurality of users.

According to the present technology, it is possible to group users who have high compatibility with each other and find users who have higher compatibility with each other with high accuracy. Further, the finding of users who have higher compatibility with each other with high accuracy makes it possible to reduce the time and cost required for making a match between users who have high compatibility with each other. The effects described here are not necessarily limited and may be any of the effects described in the present disclosure.

### BRIEF DESCRIPTION OF DRAWINGS

FIG. 1 is a diagram illustrating an example of a system configuration of an information processing system.

FIG. 2 is a diagram illustrating an example of a hardware configuration of an information processing device.

FIG. 3 is a diagram illustrating an example of a hardware configuration of a biological information acquisition device.

FIG. 4 is a diagram illustrating an example of a hardware configuration of a user terminal.

FIG. 5 is a flowchart illustrating an example of an operation of the information processing system.

FIG. 6 is a flowchart illustrating an example of processing of grouping as a subroutine.

FIG. 7 is a conceptual diagram for explaining an example of a matchmaking space.

FIG. 8 is a conceptual diagram for explaining an example of a matchmaking space.

### DESCRIPTION OF EMBODIMENTS

Hereinafter, preferable embodiments for implementing the present technology will be described with reference to the drawings. The embodiments which will be described below show typical embodiments of the present technology, and the scope of the present technology is not limited to these embodiments. The present technology will be described in the following order.
1. First Embodiment (Information Processing System)
(1) System Configuration
(2) Hardware Configuration
(3) Target Users
(4) Operations
(5) Application Example
2. Second Embodiment (Data Generation Method)
3. Third Embodiment (Grouping Model Generation Method)
4. Fourth Embodiment (Grouping Model Learning Method)
5. Fifth Embodiment (Emotion Estimation Model Generation Method)
6. Sixth Embodiment (Grouping User Information Generation Method)

### 1. First Embodiment (Information Processing System)

An information processing system according to a first embodiment of the present technology is a system that groups a plurality of target users (hereinafter also simply referred to as target users) based on biological information of the target users.

### (1) System Configuration

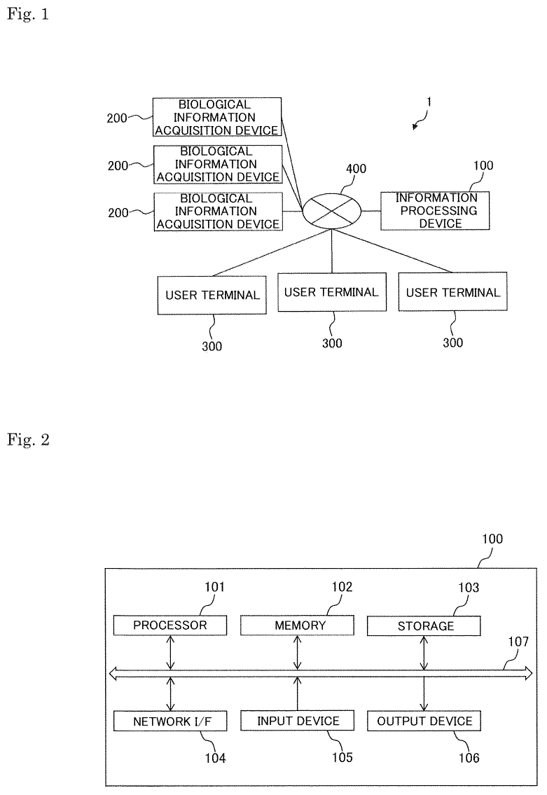

A system configuration of the information processing system 1 according to the first embodiment will be described with reference to FIG. 1. FIG. 1 is a diagram illustrating an example of the system configuration of the information processing system 1. The information processing system 1 includes an information processing device 100, biological information acquisition devices 200, and user terminals 300. The information processing device 100, the biological information acquisition devices 200, and the user terminals 300 are communicably connected to each other via a network 400. The network 400 is a communication network through which data is transmitted and received, and can be, for example, the Internet, a telephone network, a mobile communication network, a satellite communication network, a dedicated line network, a local area network (LAN), or a combination thereof. The network 400 may be a wired network, or a wireless network including Wi-Fi (registered trademark) and Bluetooth (registered trademark), or a combination thereof.

The information processing device 100 performs processing of grouping a plurality of target users based on biological information of the plurality of users. The information processing device 100 can be, for example, a server device. The server device may include one or more physical servers, or one or more virtual servers constructed on one or more physical servers. The plurality of physical servers may be located in geographically the same location, or may be geographically distributed.

The biological information acquisition device 200 is a device that acquires biological information of a target user. The biological information acquisition device 200 is also a device carried by the target user. Examples of form of the biological information acquisition device 200 include various wearable terminals such as headband type, eyewear type, neckband type, wristband type, wristwatch type, ring type, belt type, clothing type, and accessory type; a mobile terminal such as a mobile phone, a smartphone, and a tablet terminal; and any electronic device such as a medical device, a gaming device, and a household appliance. The biological information acquisition device 200 may be configured of one physical device, or may be configured of a plurality of physical devices. For example, the biological information acquisition device 200 may be configured of a wearable terminal that detects biological information and a mobile terminal that is communicably connected to the wearable terminal and has a function of processing the biological information. Although three biological information acquisition devices 200 are illustrated in FIG. 1, the number of biological information acquisition devices 200 is not limited to this.

The user terminal 300 is a computer device used by a user. Examples of the user terminal 300 include a mobile phone, a smartphone, a tablet terminal, and a personal computer. Although three user terminals 300 are illustrated in FIG. 1, the number of user terminals 300 is not limited to this.

### (2) Hardware Configuration

A hardware configuration of the information processing system 1 according to the first embodiment will be described with reference to FIGS. 2 to 4.

(2-1) Information Processing Device

A hardware configuration of the information processing device 100 included in the information processing system 1 will be described with reference to FIG. 2. FIG. 2 is a diagram illustrating an example of the hardware configuration of the information processing device 100.

The information processing device 100 includes one or more processors 101 and one or more memories 102.

The one or more processors 101 are each configured of, for example, a central processing unit (CPU), and control operations of the information processing device 100. The one or more memories 102 are configured of, for example, computer memories such as read only memory (ROM) and random access memory (RAM), and store instructions that, when executed by the one or more processors 101, cause the information processing device 100 to execute operations.

The information processing device 100 can include a storage 103, a network interface 104, an input device 105, and an output device 106.

The storage 103 includes, for example, a hard disk drive (HDD) and a solid state drive (SSD), and stores information and programs related to the operations and use of the information processing device 100. The network interface 104 is an interface for communicating with other devices via the network 400 (FIG. 1). The input device 105 is a device that receives input of information to the information processing device 100 including, for example, a keyboard, a mouse, a touch panel, and a button interface. The output device 106 is a device for outputting data and processing results, including, for example, a display, a printer, and a speaker.

The processor 101, the memory 102, the storage 103, the network interface 104, the input device 105, and the output device 106 are connected to each other by a bus 107. Although each piece of hardware is illustrated as being single piece in FIG. 2, this is merely an example and each piece of hardware may include one or more pieces.

(2-2) Biological Information Acquisition Device

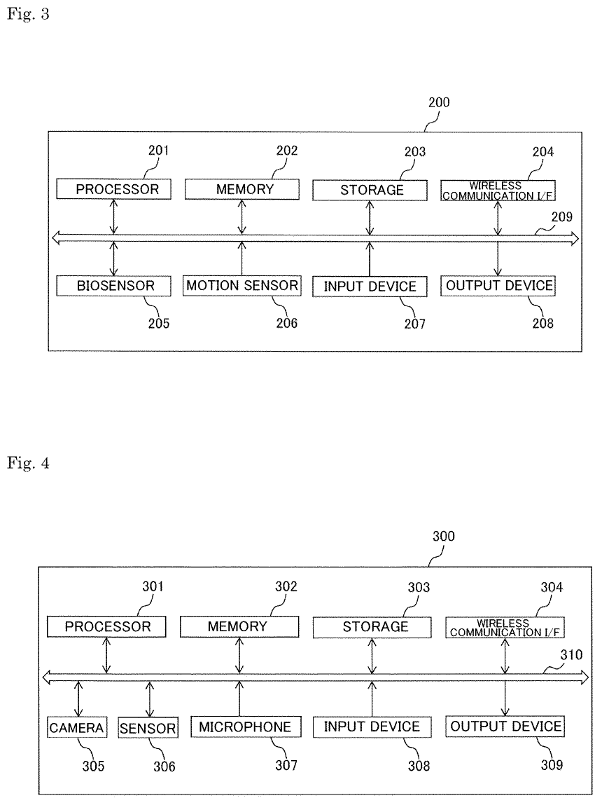

A hardware configuration of the biological information acquisition device 200 included in the information processing system 1 will be described with reference to FIG. 3. FIG. 3 is a diagram illustrating an example of the hardware configuration of the biological information acquisition device 200.

The biological information acquisition device 200 can include a processor 201, a memory 202, a storage 203, a wireless communication interface 204, and a biosensor 205.

The processor 201 is, for example, a central processing unit (CPU), and controls operations of the biological information acquisition device 200. The memory 202 includes, for example, a read only memory (ROM) and a random access memory (RAM), and stores instructions that, when executed by the processor 201, cause the biological information acquisition device 200 to execute operations. The storage 203 includes, for example, a hard disk drive (HDD) and a solid state drive (SSD), and stores information and programs related to the operations and use of the biological information acquisition device 200. The wireless communication interface 204 is an interface for communicating with other devices via the network 400 (FIG. 1). The biosensor 205 includes one or more sensors that acquire biological information of the target user.

The term “biological information” as used in the present technology refers to biological information that is related to a biological reaction of the autonomic nervous system and that has a correlation with emotion. The biological information does not include information related to voluntary movements, such as facial expressions, gestures, voices, location information, velocity, and acceleration. Specifically, the biological information can include one or more pieces of information selected from pulse, heartbeat, blood pressure, vasomotion, perspiration, skin temperature, respiration, and brain waves. Therefore, specifically, the biosensor 205 includes one or more sensors selected from a pulse sensor, a pulse wave sensor, a heart rate sensor, a blood pressure sensor, a blood flow sensor, a perspiration sensor, a temperature sensor, a respiration sensor, and a brain wave sensor.

The biological information acquisition device 200 may include a motion sensor 206, an input device 207, and an output device 208 as required.

The motion sensor 206 can be used to detect specific gestures made by the user to understand the user's intention. The input device 207 is a device for inputting various operation signals to the biological information acquisition device 200, including, for example, a touch panel and buttons. The input device 207 can be used to receive information from the user. The output device 208 is a device for outputting information, including, for example, a display such as a liquid crystal display or an organic EL display, and a speaker. The output device 208 can be used to notify the user of information or prompt the user to take a particular action.

The processor 201, the memory 202, the storage 203, the wireless communication interface 204, the biosensor 205, the motion sensor 206, the input device 207, and the output device 208 are connected to each other by a bus 209. Although each piece of hardware is illustrated as being single piece in FIG. 3, this is merely an example and each piece of hardware may include one or more pieces.

(2-3) User Terminal

A hardware configuration of the user terminal 300 included in the information processing system 1 will be described with reference to FIG. 4. FIG. 4 is a diagram illustrating an example of the hardware configuration of the user terminal 300.

The user terminal 300 can include a processor 301, a memory 302, a storage 303, a wireless communication interface 304, a camera 305, a sensor 306, a microphone 307, an input device 308, and an output device 309.

The processor 301 is, for example, a central processing unit (CPU), and controls operations of the user terminal 300. The memory 302 includes, for example, a read only memory (ROM) and a random access memory (RAM), and stores instructions that, when executed by the processor 301, cause the user terminal 300 to execute operations. The storage 303 includes, for example, a hard disk drive (HDD) and a solid state drive (SSD), and stores information and programs related to the operations and use of the user terminal 300. The wireless communication interface 304 is an interface for communicating with other devices via the network 400 (FIG. 1).

The camera 305 includes an imaging device such as a charge coupled device (CCD) or a complementary metal oxide semiconductor (CMOS). The camera 305 can be used to acquire image information of the user's face as the subject. The sensor 306 includes, for example, a GPS sensor, a geomagnetic sensor, an acceleration sensor, a gyro sensor, and a motion sensor. The sensor 306 can be used to acquire information on the user such as the user's location information, movement speed, movement direction, and movement distance, and to detect specific gestures made by the user to understand the user's intention. The microphone 307 converts voice input to the user terminal 300 into a voice signal. The microphone 307 can be used to acquire sound information including a speech voice of the user. The input device 308 is a device for inputting various operation signals to the user terminal 300, including, for example, a touch panel, a button interface, and a keyboard. The input device 308 can be used to receive information from the user. The output device 309 is a device for outputting various information, including, for example, a display such as a liquid crystal display or an organic EL display, and a speaker. The output device 309 can be used to notify the user of information or prompt the user to take a particular action.

The processor 301, the memory 302, the storage 303, the wireless communication interface 304, the camera 305, the sensor 306, the microphone 307, the input device 308, and the output device 309 are connected to each other by a bus 310. Although each piece of hardware is illustrated as being single piece in FIG. 4, this is merely an example and each piece of hardware may include one or more pieces.

### (3) Target Users

Target users for the information processing system 1 according to the first embodiment will be described. The information processing system 1 according to the present embodiment is a system that groups users who have high compatibility with each other. In other words, the information processing system 1 according to the present embodiment can divide the target users into two or more groups from the viewpoint of compatibility.

Specifically, the target users for the information processing system 1 according to the present embodiment are users who are in a situation where the user oneself can evoke emotions about other users. The situation where the user oneself can evoke emotions about other users may be, for example, a situation where the user oneself can communicate directly or online with other users. The target users are not limited to a group of users who can actually meet directly, but may include users who can meet online using a web system.

The target users are preferably a plurality of users who each carry the biological information acquisition device 200 and the user terminal 300. The term “carrying” means that the user actually wears or holds it. This makes it possible to exchange information between the target user and the information processing system 1 more instantaneously.

### (4) Operations

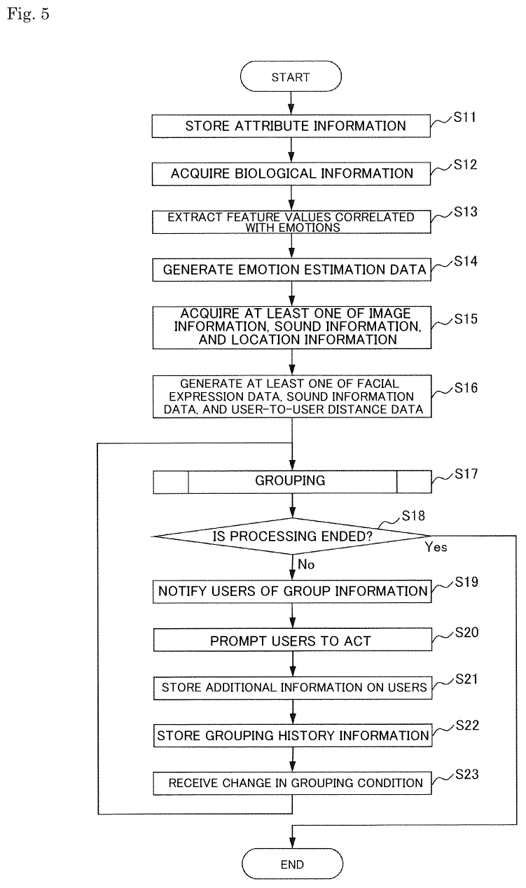

Operations of the information processing system 1 according to the present embodiment will be described in detail with reference to FIG. 5. FIG. 5 is a flowchart illustrating an example of an operation of the information processing system 1.

First, the information processing device 100 receives input of attribute information of the plurality of users and stores the attribute information of the plurality of users in the one or more memories 102 (step S11). Examples of the attribute information include gender, age, hometown, educational background, work history, hobby, and personality. Examples of the personality include a result of measurement of the Big Five personality traits on the user and a user's self-reported result.

Next, the biological information acquisition device 200 acquires biological information of the plurality of users (step S12). Specifically, the biological information acquisition device 200 acquires time-series data of the biological information of the plurality of users in real time. In other words, the biological information of the plurality of users can be time series data of the biological information of the plurality of users acquired in real time by the one or more biosensors 205 of the biological information acquisition device 200.

Next, the biological information acquisition device 200 extracts feature values correlated with emotions from the time-series data of the biological information of the plurality of users (step S13).

For example, in a case where the one or more biosensors 205 included in the biological information acquisition device 200 include a heartbeat sensor, the heartbeat sensor can be a sensor that can extract heart rate and heart rate variability, which are known as peripheral nervous system activity, by photoplethysmography (PPG) or electrocardiogram (ECG). In this case, the processor 201 of the biological information acquisition device 200 can extract heart rate and heart rate variability as feature values correlated with emotions.

For example, in a case where the one or more biosensors 205 included in the biological information acquisition device 200 include a perspiration sensor can be a sensor that measures skin conductance to detect mental perspiration, which is known as an index representing activity of peripheral nerves, particularly, sympathetic nerves. In this case, the processor 201 of the biological information acquisition device 200 can execute processing of extracting feature values correlated with emotions from the skin conductance. Specifically, the processor 201 of the biological information acquisition device 200 can extract, from the skin conductance, the skin conductance response (SCR) representing an instantaneous perspiration activity and the skin conductance level (SCL) representing a gradual change in the condition of the skin surface.

For example, in a case where the one or more biosensors 205 included in the biological information acquisition device 200 include a brain wave sensor, the brain wave sensor can be an electroencephalograph (EEG), which measures weak periodic potential fluctuations emitted from nerve cells in the brain by using electrodes. The electroencephalograph can be used to detect 0 waves, which are observed in a state of concentration, a waves, which are observed in a state of relaxation, and the like. In this case, the processor 201 of the biological information acquisition device 200 can perform frequency analysis or statistical analysis on the observed brain waves to extract feature values correlated with human emotions.

Next, the information processing device 100 generates emotion estimation data by using the biological information acquired in step S12 and/or the feature values correlated with emotions extracted from the time-series data of the biological information in step S13 (step S14). For example, the information processing device 100 generates emotion estimation data by using the time-series data of the biological information of the plurality of users acquired in real time. The emotion estimation data is data obtained by estimating the emotions of the user by using the correlation between the biological information and the emotions.

The emotion estimation data may be data output from an emotion estimation model generated in advance by machine learning. The emotion estimation model will be described below in a fifth embodiment of the present technology (an emotion estimation model generation method). The emotion estimation data may be generated by artificial intelligence within the information processing device 100 or within another device.

Next, the user terminal 300 acquires at least one of image information of faces of the plurality of users as subjects, sound information including speech information of the plurality of users, and location information of the plurality of users (step S15). The user terminal 300 may acquire time-series data of at least one of the image information, sound information, and location information in real time.

The subject(s) to be included in one piece of image information may be the face of one user or the faces of two or more users. The speech information to be included in one piece of sound information may be the speech information of one user or the speech information of two or more users.

Next, the information processing device 100 uses at least one of the image information, sound information, and location information acquired in step S15 to generate at least one of facial expression data, speech data, and user-to-user distance data (step S16). Specifically, the information processing device 100 executes at least one of: generating facial expression data by using the image information of the faces of the plurality of users as subjects, generating speech data by using the sound information including speech information of the plurality of users, and generating user-to-user distance data by using the location information of the plurality of users.

The facial expression data can be generated, for example, by detecting facial regions from the image information of the faces of the plurality of users as subjects, and recognizing facial expressions from parts of each face. The speech data can be generated, for example, by using a known method of recognizing time-series data of speech information by using a deep learning framework. The user-to-user distance data can be generated, for example, by calculating physical distances between users as Euclidean distances from the coordinates representing location information of the users.

Next, the information processing device 100 groups the plurality of users based on the biological information of the plurality of users (step S17). Specifically, the information processing device 100 groups the plurality of users based on the time-series data of the biological information of the plurality of users acquired in real time. The grouping of the plurality of users means dividing the plurality of users into two or more groups.

Each of the plurality of users can communicate with other users, for example, directly or online. An impression of high or low compatibility with another user can be formed by emotional changes that occur through communication with the other user. A user's emotional change can be detected as a change in the biological information of the user. The information processing device 100 utilizes the correlation between high/low compatibilities and emotions, and the correlation between emotions and biological information to group the plurality of users into two or more groups so that users who have higher compatibility with each other are in a same group.

The grouping of the plurality of users based on the biological information of the plurality of users (step S17) can include creating user pairs each composed of two users included in the plurality of users based on the biological information of the plurality of users. Specifically, the two or more groups created by grouping in step S17 may include a group composed of three or more users, a group composed of pairs of two users, or a mixture of these groups. For example, if the purpose is to make a match between target users on a one-to-many or many-to-many relationship, the grouping may include processing of creating a group composed of three or more users. For example, if the purpose is to make a match between target users on a one-to-one relationship, the grouping preferably includes processing of creating a user pair composed of two users.

Further, the information processing device 100 may repeat the grouping of the plurality of users based on the biological information of the plurality of users (step S17). For example, the grouping may be repeated so that the number of users included in one group is gradually reduced to gradually narrow down users who have high compatibility with each other. Further, when the grouping is repeated, the grouping conditions may be changed as required each time the grouping is performed. Repeating the processing of grouping while changing the grouping conditions makes it possible to improve the accuracy of matchmaking.

The grouping is performed based on the biological information of the plurality of users as described above. However, the grouping may be performed further using information other than the biological information. The grouping based on the biological information and other information contributes to determining whether users have high or low compatibility with each other based on a plurality of viewpoints, so that it is possible to accurately find users who have higher compatibility with each other. Examples of the other information include the attribute information of the users stored in step S11, the feature values correlated with emotions extracted in step S13, the emotion estimation data generated in step S14, the image information, sound information, and location information acquired in step S15, and at least one piece of information selected from the facial expression data, speech data, and user-to-user distance data generated in step S16.

As an example, the grouping of the plurality of users based on the biological information of the plurality of users (step S17) includes grouping the plurality of users based on the biological information of the plurality of users and at least one of: the image information of faces of the plurality of users as subjects, the sound information including speech voices of the plurality of users, and the location information of the plurality of users.

As another example, the grouping of the plurality of users based on the biological information of the plurality of users (step S17) includes grouping the plurality of users based on the biological information of the plurality of users and the attribute information of the plurality of users.

As another example, the grouping of the plurality of users based on the biological information of the plurality of users (step S17) includes grouping the plurality of users based on the emotion estimation data generated using the biological information of the plurality of users.

As another example, the grouping of the plurality of users based on the biological information of the plurality of users (step S17) includes grouping the plurality of users based on at least one of: the emotion estimation data generated using the biological information of the plurality of users, the facial expression data generated using the image information of faces of the plurality of users as subjects, the speech data generated using the sound information including speech voices of the plurality of users, and the user-to-user distance data generated using the location information of the plurality of users.

The grouping (step S17) described above in detail may be executed using a grouping model generated in advance by machine learning. Details of the grouping model will be described below in a third embodiment of the present technology (a grouping model generation method). Further, the grouping (step S17) may be executed by artificial intelligence within the information processing device 100.

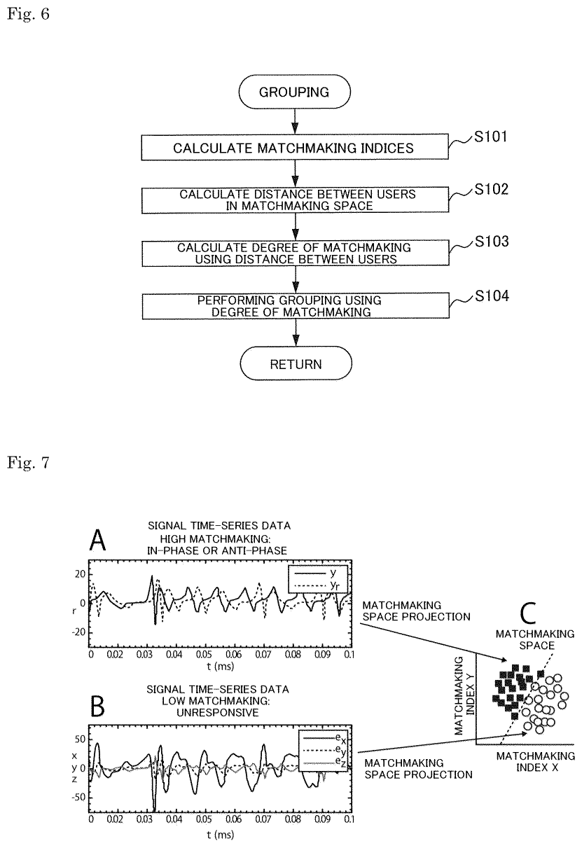

Next, a specific flow of the processing of grouping (step S17) will be described with reference to FIG. 6. FIG. 6 is a flowchart illustrating an example of the processing of grouping (step S17) illustrated in FIG. 5 as a subroutine.

First, the information processing device 100 calculates a plurality of matchmaking indices (step S101). Specifically, the information processing device 100 calculates a plurality of matchmaking indices for a user pair composed of two users included in the plurality of users. The two users can be any two selected from among the plurality of users.

The matchmaking indices are indices used in processing of calculating a degree of matchmaking, which will be described later. The term “degree of matchmaking” as used in the present technology is a value indicating the degree of compatibility between the two users of the user pair. The lower the degree of matchmaking, the higher the compatibility between the users.

The calculating of the plurality of matchmaking indices includes calculating matchmaking indices based on the biological information of the users of the user pair. The calculating of the plurality of matchmaking indices includes calculating matchmaking indices specifically based on the time-series data of the biological information of the users of the user pair, which is acquired in real time.

The processing of calculating the matchmaking indices based on the biological information will be specifically described with an example. The calculating of the matchmaking indices can include performing in-phase/anti-phase analysis using the time-series data of the biological information of the users of the user pair to calculate a first matchmaking index. In calculating the first matchmaking index by means of the in-phase/anti-phase analysis, for example, the following Equation (I) can be used:

r=f(t)*g(t−τ) (I)

(When the users of the user pair are user A and user B, in Equation (I), r indicates the first matchmaking index, f(t) indicates time-series data of biological information of user A at a certain time, g(t) indicates time-series data of biological information of user B at a certain time, and τ indicates a deviation of timing of a physiological index with respect to an external stimulus that takes positive and negative values.)

Examples of the physiological index include heart rate, heart rate variability, mental perspiration, and electroencephalogram. By using the physiological index, a feature value correlated with emotion included in the time-series data of the biological information can be extracted. It is known that the physiological index is observed with a delay from the response to an external stimulus. As such, in Equation (I), τ is a value indicating a deviation of timing of the observed physiological index from timing of the external stimulus.

The value range of τ varies depending on the type of biological information of the user used in Equation (I). The value range of τ corresponding to the type of biological information can be stored in advance in the one or more memories 102 of the information processing device 100 as known information. For example, it is known in the academic field that physiological indices such as heart rate, heart rate variability, and mental perspiration (SCR, SCL), which are observed as autonomic nerve activity, have a delay of the order of several seconds to several tens of seconds from the response to an external stimulus. More specifically, heart rate and heart rate variability are known to generate a response delay of the order of several seconds to several tens of seconds, and accordingly, the corresponding range of τ can be, for example, 1.0 seconds <|T|<100 seconds. Psychotic perspiration is observed with a delay of about 1 to 5 seconds after the response to an external stimulus, and accordingly, the corresponding range of τ can be, for example, 1 second <|T|<5 seconds. Physiological indices such as brain waves (0 waves and a waves), which are observed as central nervous activity, are observed with a delay of several milliseconds after the response to an external stimulus, and accordingly, the corresponding range of τ can be, for example, 0.001 seconds <|T|<1.0 seconds.

The processing of calculating the matchmaking indices based on the biological information will be described with another example. The calculating of the matchmaking indices can include performing calculation of an index of absolute difference value using the time-series data of the biological information of the users of the user pair to calculate a second matchmaking index. In calculating the second matchmaking index by means of the calculation of an index of absolute difference value, for example, the following Equation (II) can be used:

diff=|f(t)*g(t−τ)| (II)

(When the users of the user pair are user A and user B, in Equation (II), diff indicates the second matchmaking index, f(t) indicates time-series data of biological information of user A at a certain time, g(t) indicates time-series data of biological information of user B at a certain time, and τ indicates a deviation of timing of a physiological index with respect to an external stimulus that takes positive and negative values.)

In Equation (II), τ is the same as τ described in Equation (I), and accordingly, the same applies to τ in Equation (II).

An example of calculating matchmaking indices based on the biological information has been described above. However, the procedure for calculating the matchmaking indices is not limited to this example. The calculating of the plurality of matchmaking indices for the user pair (step S101) can include calculating matchmaking indices based on information other than the biological information. Examples of The other information include the attribute information of the users stored in step S11 (FIG. 5), the feature values correlated with emotions extracted in step S13 (FIG. 5), the emotion estimation data generated in step S14 (FIG. 5), the image information, sound information, and location information acquired in step S15 (FIG. 5), and at least one piece of information selected from the facial expression data, speech data, and user-to-user distance data generated in step S16 (FIG. 5). Also in the calculation of the matchmaking indices based on the other information, the above-described in-phase/anti-phase analysis and calculation of an index of absolute difference value can be used.

The processing of grouping will continue to be described with reference to FIG. 6. The information processing device 100 then calculates a distance between the users of the user pair based on a matchmaking index vector of each user in a matchmaking space composed of the plurality of matchmaking indices (step S102). In other words, the matchmaking index vector calculated for each user pair is projected onto the matchmaking space.

The matchmaking space will now be described with reference to FIG. 7. FIG. 7 is a conceptual diagram for explaining an example of the matchmaking space.

In FIGS. 7, A and B are graphs showing time-series signal data for a plurality of users. The two pieces of time-series data shown in A of FIG. 7 have an in-phase or anti-phase relationship. It is expected that the degree of matchmaking between users exhibiting such a relationship is high. On the other hand, the three pieces of time-series data shown in B of FIG. 7 do not have a relationship in which they are responsive to each other. In such a case, it is expected that the degree of matchmaking between users is low. Matchmaking indices can be calculated from the information on the users as shown in A and B of FIG. 7. The calculated matchmaking indices are projected onto the matchmaking space. In FIG. 7, C illustrates the matchmaking space composed of two matchmaking indices (matchmaking index X and matchmaking index Y). In the matchmaking space as illustrated in C of FIG. 7, a distance between users is calculated for each user pair.

Returning to FIG. 6, the processing of grouping will be further described. The information processing device 100 calculates a degree of matchmaking between the users of the user pair by using the distance between the users in the matchmaking space (step S103). The calculating of the degree of matchmaking can include calculating the degree of matchmaking by, for example, the following Equation (III):

[Math. 2]

D_{w}(X_{personA},X_{personB})=\sqrt{Σⱼ₌₁^{N}wⱼ(X_{personA,j}−X_{personB,j})²} (III)

(When the users of the user pair are user A and user B, in Equation (III), D_{w}(X_{personA}, X_{personB}) indicates the degree of matchmaking, N indicates the number of dimensions of the matchmaking space, X_{personA} indicates a matchmaking index vector of user A, X_{personB} is a matchmaking index vector of user B, j indicates an element number of the matchmaking index vector, and w (w=w₁, w₂, . . . , w_{N}) indicates a weight vector preset for each matchmaking index.) The degree of matchmaking (D_{w}(X_{personA}, X_{personB})) in Equation (III) is, in other words, the distance between the users of the user pair, which is calculated based on the matchmaking index vector of the user in the matchmaking space. The lower the matchmaking degree, that is, the shorter the distance between the users in the matchmaking space, the higher the compatibility between the users.

The weight vector (w) preset for each matchmaking index in Equation (III) is weighting for each matchmaking index set according to the importance of the matchmaking index. The value of w can be stored in advance in the one or more memories 102 of the information processing device 100. The preset value of w may be changed as appropriate.

Next, the information processing device 100 groups the plurality of users by using the matchmaking degrees described above (step S104). The grouping of the plurality of users by using the matchmaking degrees (step S104) can include calculating a set of best user pairs (i, j) by, for example, the following Equation (IV) using the matchmaking degrees to group the plurality of users so that pairs of users who have a lower degree of matchmaking D_{w}(Xᵢ, Xⱼ) are in a same group.

[Math. 3]

Σ_{(i,j)∈A}w_{priority}D_{w}(Xᵢ,Xⱼ) (IV)

(In Equation (IV), i and j indicate element numbers representing users, A indicates a set of all user pairs (i, j), and w_{priority} indicates an optimization term based on a weight preset for each matchmaking index.)

The value of the optimization term (w_{priority}), which is based on the weight preset for each matchmaking index, in Equation (IV) can be stored in advance in the one or more memories 102 of the information processing device 100. The preset value of w_{priority} may be changed as appropriate.

The degree of matchmaking (D_{w}(Xᵢ, Xⱼ)) in Equation (IV) is, in other words, the distance between the users of the user pair, which is calculated based on the matchmaking index vector of the user in the matchmaking space. The lower the matchmaking degree, that is, the shorter the distance between the users in the matchmaking space, the higher the compatibility between the users.

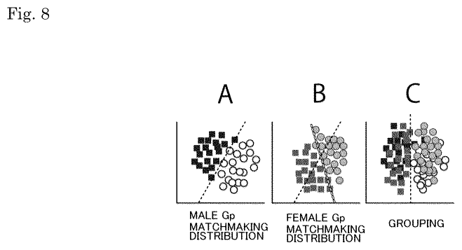

A specific example of the matchmaking space will now be described with reference to FIG. 8. FIG. 8 is a conceptual diagram for explaining an example of the matchmaking space.

A case of matchmaking between male and female will be taken as an example. In FIG. 8, A shows a distribution of male users in the matchmaking space, and in FIG. 8, B shows a distribution of female users in the matchmaking space. In FIG. 8, C shows the matchmaking space when the male and female users shown in A and B of FIG. 8 are divided into two groups. In C of FIG. 8, male-female pairs that each have a short distance between male and female in the matchmaking space are grouped into the same group. Preferably, the distance between users in the matchmaking space is minimized, as illustrated in FIG. 8.

The grouping (step S104) using the degrees of matchmaking illustrated in FIG. 6 has been described in detail above. The grouping as a subroutine ends by the execution of step S104. When the subroutine ends, the processing returns to the main routine illustrated in FIG. 5.

Returning to FIG. 5, an example of the operation after the grouping (step S17) will be described. If no further processing is performed after the grouping (step S18: Yes), the processing in the information processing system 1 ends. On the other hand, if further processing is performed after the grouping (step S18: No), the processing in the information processing system 1 proceeds to the next.

Next, the information processing device 100 may perform processing for notifying the plurality of users of group information on a result of grouping the plurality of users (step S19). Further, the information processing device 100 may perform processing for prompting the plurality of users to act in a way that a physical distance between users in a same group becomes shorter (step S20). By executing the processing of step S20, the group including users who have high compatibility with each other is formed as a physical cluster. The information processing device 100 preferably performs at least one of the processing of step S19 and the processing of step S20, and more preferably performs both the processing of step S19 and the processing of step S20.

The information processing device 100 may repeat the processing of step S17 and at least one of the processing of step S19 and the processing of step S20. For example, the information processing device 100 may execute the processing in a way: step S17→step S19 and/or step S20→step S17→step S19 and/or step S20→step S17.

On the other hand, after step S19 and/or step S20 are executed and before step S17 is executed again, steps S21 to S23, which are described below, may be executed.

The information processing device 100 may receive additional information on a user(s) and store the additional information about the user(s) in the one or more memories 102 (step S21). Using the additional information in the subsequent processing of grouping makes it possible to find users who have high compatibility with each other with higher accuracy and improve the compatibility between grouped users.

The additional information on the user(s) may be attribute information of one or more users, for example. When the information processing device 100 receives the attribute information of the one or more users, the storing of the attribute information in the one or more memories 102 may include updating the attribute information of the user(s) already stored in the memory(s) 102 in step S11.

The additional information on the user(s) may be measurements of the performance of the user(s) on a given subject, such as, for example, a rating by a third party evaluator.

In another example, the additional information on the user(s) may be feedback data from one or more users. The feedback data is data including information such as user's intentions, opinions, reactions, and evaluations. For example, the biological information acquisition device 200 or the user terminal 300 can detect information input by the user, or detect a specific gesture made by the user with various sensors, and transmit the detected information as information on the user's intention to the information processing device 100. When receiving the information on the user's intention, the information processing device 100 stores that intention information in the one or more memories 102 as feedback data from the user. For example, if user A has a favorable impression on user B during a conversation with user B and has an intention to continue the conversation with user B, the biological information acquisition device 200 or the user terminal 300 can transmit that intention information as feedback data to the information processing device 100.

The information processing device 100 may also receive grouping history information that is a result of grouping the plurality of users in the past based on the attribute information of the plurality of users, and store the grouping history information in the one or more memories 102 (step S22). Using the grouping history information for each piece of the attribute information in the subsequent processing of grouping makes it possible to find users who have high compatibility with each other with higher accuracy and improve the compatibility between grouped users.

Further, the information processing device 100 may receive a change in a grouping condition and store the changed grouping condition in the one or more memories 102 (step S23). The change in the grouping condition is preferably a change in the grouping condition based on the additional information on the user(s) in step S20. Accordingly, the information processing device 100 can perform the grouping based on a condition that takes into account the additional information on the user(s). Examples of that grouping condition include the value of the weight vector (w) preset for each matchmaking index in Equation (III) and the value of the optimization term (w_{priority}) based on the weight preset for each matchmaking index in Equation (IV). The changing of the grouping condition based on the additional information on the user(s) makes it possible to find users who have high compatibility with each other with higher accuracy and improve the compatibility between grouped users.

The information processing device 100 groups the plurality of users again based on the biological information of the plurality of users (step S17). In the second and later grouping (step S17), the grouping can be performed based on at least one of: the additional information on the user(s) stored in step S21, the grouping history information for each piece of the attribute information stored in step S22, and the grouping condition changed in step S23.

Accordingly, as an example, the grouping of the plurality of users based on the biological information of the plurality of users (step S17) can include grouping the plurality of users based on the biological information of the plurality of users and the additional information on the users. In this case, the calculating of the plurality of matchmaking indices for each user pair (step S101 in FIG. 6) includes calculating the matchmaking indices based on the additional information on the users.

As another example, the grouping of the plurality of users based on the biological information of the plurality of users (step S17) can include grouping the plurality of users based on the biological information of the plurality of users, the attribute information of the plurality of users, and the grouping history information for each piece of the attribute information. In this case, the calculating of the plurality of matchmaking indices for each user pair (step S101 in FIG. 6) includes calculating the matchmaking indices based on the grouping history information for each piece of the attribute information.

As another example, the grouping of the plurality of users based on the biological information of the plurality of users (step S17) can include the grouping based on the changed grouping condition. If the changed grouping condition includes the value of the weight vector (w) preset for each matchmaking index in Equation (III) and/or the value of the optimization term (w_{priority}) based on the weight preset for each matchmaking index in Equation (IV), then step S103 and/or step S104 of FIG. 6 can be executed based on such a changed value.

Furthermore, as another example, the grouping of the plurality of users based on the biological information of the plurality of users (step S17) may be executed using a grouping model generated by a fourth embodiment of the present technology (a grouping model learning method) described below. For details of the grouping model, refer to the description of the fourth embodiment of the present technology below.

In the operations of the information processing system 1 according to the present embodiment described in detail above, the execution order can be freely changed as long as there is no contradiction.

Further, in the information processing system 1 according to the present embodiment, the biological information acquisition device 200 may be configured to execute part of the operations executed by the information processing device 100 and/or the user terminal 300. Similarly, the user terminal 300 may be configured to execute part of the operations executed by the information processing device 100 and/or the biological information acquisition device 200.

### (5) Application Example

An application example of the information processing system 1 according to the present embodiment will be described. Specifically, the application example will be described in which it is assumed that an operator of a matchmaking service uses the information processing system 1 according to the present embodiment to provide a service for matchmaking between male and female users at a matchmaking party where a specific number of male and female users gather.

In this application example, a matchmaking system is an example of the information processing system 1 described above. A server device is an example of the information processing device 100 described above. A wearable device is an example of the biological information acquisition device 200 described above. A smartphone is an example of the user terminal 300 described above.

(5-1) Environmental Conditions of Matchmaking Party
1) The range of activities of users is a limited space (e.g., an indoor event venue).
2) Tables and chairs for the users are arranged in the limited space.
3) The operator knows the personal information of the users.
4) The personal information is stored in the server device. The personal information must include the contact information of the users such as phone number, e-mail address, and postal address.
5) Each of the users carries a smartphone.

(5-2) Operation of Matchmaking System
1) The matchmaking system acquires the location information of the users by using information obtained from the wearable device or smartphone.
2) Each user can transmit information on the user's intention to the server device by using the wearable device or smartphone.
3) The server device calculates the degrees of matchmaking to group male and female users.
4) A dedicated application for the matchmaking system is installed on the smartphone.

(5-3) Holding Matchmaking Party
1) At the reception of the matchmaking party, the operator lends wearable devices to all users.
2) Each user puts on the wearable device and synchronizes the user's smartphone with the wearable device.
3) Each user takes a seat at a table of the user's choice.
4) Each user remains seated and waits until all users are seated. A user who finds a partner of interest while waiting is allowed to transmit information on the user's intention to the server device via the wearable device or smartphone.
5) Once all users are seated, the matchmaking party begins.
6) Users talk with other users. Meanwhile, the server device calculates first degrees of matchmaking based on the location information of the users and the biological information of the users acquired from the wearable devices, and determines whether users seated nearby have high compatibility with each other (Phase 1).
7) The server device groups male and female users by using the first degrees of matchmaking, and notifies their smartphones of a proposal to change seats so that users who have a low degree of matchmaking, that is, high compatibility can sit at the same table.
8) A user who has changed the seat in accordance with the proposal from the server device talks with other users. Meanwhile, the server device extracts a difference from the biological information of the user in Phase 1, calculates second degrees of matchmaking, and determines whether the user has high compatibility with users seated nearby (Phase 2).
9) The server device groups male and female users by using the second degrees of matchmaking, and notifies their smartphones of a proposal to change seats so that users who have a low degree of matchmaking, that is, high compatibility can sit at the same table.
10) A user who has changed the seat in accordance with the proposal from the server device talks with other users. Meanwhile, the server device extracts a difference from the biological information of the user in Phase 1, calculates third degrees of matchmaking, and determines whether the user has high compatibility with users seated nearby (Phase 3).
11) The matchmaking party ends. Meanwhile, the server device transmits information on the degrees of matchmaking to the user's smartphones, and prompts users who have a low degree of matchmaking, that is, high compatibility to exchange contact information that is available only within the dedicated application on the smartphone. The corresponding users determines whether to exchange the contact information. The users who have exchanged the contact information are considered to be users between whom matchmaking has been established.
12) The users between whom matchmaking has been established do not return their wearable devices to the operator, but each of the users receives a return box and a charger for the wearable device at the reception and takes them home.
13) Contact between the users between whom matchmaking has been established is limited to the dedicated application on their smartphones. At a later date, the users go on a date while wearing the wearable devices, and after the date ends, the biometric data is transmitted to the server device (Phase 4).
14) The server device calculates final degrees of matchmaking based on the pieces of information in Phases 1 to 4, and transmits the final degrees of matchmaking and results of analysis on compatibility between the users between whom matchmaking has been established to their smartphones.
15) Based on the corresponding final degree of matchmaking and result of analysis on compatibility, the user transmits intention information as to whether that user wishes to exchange the contact information with the user with whom matchmaking has been established to the server device from the dedicated application on the smartphone. This contact information refers to general contact information such as phone number, e-mail address, and address, not contact information that is available only within the dedicated application on the smartphone.
16) When the server device receives the intention information from both users between whom matchmaking has been established that they wish to exchange the contact information with each other, the server device notifies both users of the partner's contact information.
17) The corresponding user returns the wearable device to the operator.
18) If users who have exchanged the contact information through this matchmaking party get married at a later date, when they send photos of both users and a marriage registration to the operator, a specified amount of gift money will be transferred to the bank account designated by them.

### 2. Second Embodiment (Data Generation Method)

A data generation method according to a second embodiment of the present technology is a data generation method including generating group information on a result of grouping a plurality of users based on biological information of the plurality of users. The data generation method is executed by one or more processors included in a computer.

The processing of grouping the plurality of users based on the biological information of the plurality of users is as described in detail in the first embodiment (information processing system), and the same applies to the present embodiment. Therefore, the data generation method according to the present embodiment may be executed by the information processing system according to the first embodiment.

The data generation method according to the present embodiment can include generating data in which the group information and a measurement condition of the biological information when the biological information is acquired are associated with each other.

The data generated according to the present embodiment can be stored in, for example, the information processing device described in the first embodiment and used in the processing of grouping. The data generated according to the present embodiment can also be used, for example, in a grouping model generation method according to the third embodiment of the present technology described below.

### 3. Third Embodiment (Grouping Model Generation Method)

The grouping model generation method according to the third embodiment of the present technology includes, by performing machine learning using teacher data in which biological information of a plurality of users and group information on a result of grouping the plurality of users based on the biological information of the plurality of users are associated with each other, generating a grouping model that outputs the group information in response to input of the biological information of the plurality of users. The grouping model generation method is executed by one or more processors included in a computer.

The processing of acquiring the biological information of the plurality of users and the processing of grouping the plurality of users based on the biological information of the plurality of users are as described in detail in the first embodiment (information processing system), and the same applies to the present embodiment. Therefore, the teacher data in the present embodiment can be obtained by the information processing system according to the first embodiment.

Examples of the types of machine learning include, but are not limited to, support vector machine (SVM), hidden Markov model (HMM), and recurrent neural network (RNN).

### 4. Fourth Embodiment (Grouping Model Learning Method)

The grouping model learning method according to the fourth embodiment of the present technology including causing a grouping model generated by machine learning using teacher data in which biological information of a plurality of users and group information on a result of grouping the plurality of users based on the biological information of the plurality of users are associated with each other, to further learn teacher data in which the biological information, the group information, and feedback data from the users are associated with each other. The grouping model learning method is executed by one or more processors included in a computer.

The processing of acquiring the biological information of the plurality of users, the processing of grouping the plurality of users based on the biological information of the plurality of users, and the processing of receiving the feedback data from the users are as described in detail in the first embodiment (information processing system), and the same applies to the present embodiment. Therefore, the teacher data in the present embodiment can be obtained by the information processing system according to the first embodiment.

Examples of the types of machine learning include, but are not limited to, SVM, HMM, and RNN, as in the third embodiment.

### 5. Fifth Embodiment (Emotion Estimation Model Generation Method)

The emotion estimation model generation method according to the fifth embodiment of the present technology includes, by performing machine learning using teacher data in which human biological information and human emotions are associated with each other, generating an emotion estimation model that outputs emotion estimation data of a plurality of users used to group the plurality of users in response to input of biological information of the plurality of users. The emotion estimation model generation method is executed by one or more processors included in a computer.

The biological information, the method of acquiring the biological information, and the details of the emotions are as described in the first embodiment (information processing system), and the same applies to the present embodiment.

The emotion estimation data can be used, for example, to perform the processing of grouping described in the first embodiment.

### 6. Sixth Embodiment (Grouping User Information Generation Method)

A grouping user information generation method according to a sixth embodiment of the present technology is a grouping user information generation method including: aligning time axes of time-series data of biological information of a plurality of users; and outputting grouping user information used to group the plurality of users. The generation method for grouping is executed by one or more processors of a computer.

The aligning of time series of the time series data of the biological information includes aligning the time series of the time series data of the biological information by using, for example, Equation (I) and/or Equation (II) described in the first embodiment. In Equation (I) and Equation (II), τ is a value indicating a deviation of timing of the observed physiological index from timing of the external stimulus. Using Equation (I) and/or Equation (II) with τ makes it possible to correct the deviation of timing and align the time series of the time series data.

Note that the present technology can have the following configurations.

[1]

An information processing device including:
one or more processors; and
one or more memories storing instructions that, when executed by the one or more processors,
cause the information processing device to execute operations,
wherein the operations include
grouping a plurality of users based on biological information of the plurality of users.

[2]

The information processing device according to [1], wherein the grouping of the plurality of users based on the biological information of the plurality of users includes grouping the plurality of users based on
the biological information of the plurality of users, and
at least one of: image information of faces of the plurality of users as subjects, sound information including speech voices of the plurality of users, and location information of the plurality of users.

[3]

The information processing device according to [1] or [2], wherein
the one or more memories further store attribute information of the plurality of users, and
the grouping of the plurality of users based on the biological information of the plurality of users includes grouping the plurality of users based on
the biological information of the plurality of users and the attribute information of the plurality of users.

[4]

The information processing device according to [3], wherein
the one or more memories further stores grouping history information that is a result of grouping the plurality of users in the past based on the attribute information of the plurality of users, and
the grouping of the plurality of users based on the biological information of the plurality of users includes grouping the plurality of users based on
the biological information of the plurality of users, the attribute information of the plurality of users, and the grouping history information for each piece of the attribute information.

[5]

The information processing device according to any one of [1] to [4], wherein
the grouping of the plurality of users based on the biological information of the plurality of users includes grouping the plurality of users based on
emotion estimation data generated using the biological information of the plurality of users.

[6]

The information processing device according to any one of [1] to [5], wherein
the grouping of the plurality of users based on the biological information of the plurality of users includes grouping the plurality of users based on
emotion estimation data generated using the biological information of the plurality of users, and at least one of: facial expression data generated using image information of faces of the plurality of users as subjects, speech data generated using sound information including speech voices of the plurality of users, and user-to-user distance data generated using location information of the plurality of users.

[7]

The information processing device according to [5] or [6], wherein
the emotion estimation data generated using the biological information of the plurality of users is generated by
inputting the biological information of the plurality of users into an emotion estimation model generated in advance by machine learning using teacher data in which human biological information and human emotions are associated with each other.

[8]

The information processing device according to any one of [1] to [7], wherein
the grouping of the plurality of users based on the biological information of the plurality of users includes
creating user pairs each composed of two users included in the plurality of users based on the biological information of the plurality of users.

[9]

The information processing device according to any one of [1] to [8], wherein
the grouping of the plurality of users based on the biological information of the plurality of users includes
calculating a plurality of matchmaking indices for a user pair composed of two users included in the plurality of users;
calculating a distance between the users of the user pair based on a matchmaking index vector of each user in a matchmaking space composed of the plurality of matchmaking indices;
calculating a degree of matchmaking between the users of the user pair by using the distance between the users in the matchmaking space; and
grouping the plurality of users by using the degree of matchmaking, and
the calculating of the plurality of matchmaking indices includes
calculating the matchmaking indices based on the biological information of users of the user pair.

[10]

The information processing device according to [9], wherein the calculating of the matchmaking indices based on the biological information of the users of the user pair includes
performing in-phase/anti-phase analysis using time-series data of the biological information of the users of the user pair to calculate a first matchmaking index.

[11]

The information processing device according to [10], wherein the calculating of the first matchmaking index includes
calculating the first matchmaking index by Equation (I):

r=f(t)*g(t−τ) (I)
where when the users of the user pair are user A and user B, in Equation (I), r indicates the first matchmaking index, f(t) indicates time-series data of biological information of user A at a certain time, g(t) indicates time-series data of biological information of user B at a certain time, and τ indicates a deviation of timing of a physiological index with respect to an external stimulus that takes positive and negative values.

[12]

The information processing device according to any one of [9] to [11], wherein the calculating of the matchmaking indices based on the biological information of the users of the user pair includes
performing calculation of an index of absolute difference value using time-series data of the biological information of the users of the user pair to calculate a second matchmaking index.

[13]

The information processing device according to any one of [9] to [12], wherein the calculating of the degree of matchmaking between the users of the user pair by using the distance between the users in the matchmaking space includes
calculating the degree of matchmaking by Equation (III):

[Math. 4]

D_{w}(X_{personA},X_{personB})=\sqrt{Σⱼ₌₁^{N}wⱼ(X_{personA,j}−X_{personB,j})²} (III)
where the users of the user pair are user A and user B, in Equation (III), D_{w}(X_{personA}, X_{personB}) indicates the degree of matchmaking, N indicates the number of dimensions of the matchmaking space, X_{personA} indicates a matchmaking index vector of user A, X_{personB} is a matchmaking index vector of user B, j indicates an element number of the matchmaking index vector, and w (w=w₁, w₂, . . . , w_{N}) indicates a weight vector preset for each matchmaking index.

[14]

The information processing device according to any one of [1] to [13], wherein the operations include performing
at least one of: processing for notifying the plurality of users of group information on a result of grouping the plurality of users and processing for prompting the plurality of users to act in a way that a physical distance between users in a same group becomes shorter.

[15]

The information processing device according to any one of [1] to [14], wherein the operations include repeating:
grouping the plurality of users based on the biological information of the plurality of users; and at least one of: processing for notifying the plurality of users of group information on a result of grouping the plurality of users and processing for prompting the plurality of users to act in a way that a physical distance between users in a same group becomes shorter.

[16]

The information processing device according to any one of [1] to [15], wherein the operations include
receiving feedback data from one or more users.

[17]

The information processing device according to any one of [1] to [16], wherein the grouping of the plurality of users based on the biological information of the plurality of users is executed by artificial intelligence.

[18]

The information processing device according to any one of (5) to (7), wherein the emotion estimation data is generated by artificial intelligence.

[19]

The information processing device according to any one of [1] to [18], wherein
the plurality of users are a plurality of users who each carry a biological information acquisition device, and
the biological information of the plurality of users is biological information of the plurality of users acquired by the biological information acquisition devices.

[20]

A data generation method executed by one or more processors, the data generation method including
generating group information on a result of grouping a plurality of users based on biological information of the plurality of users.

[21]

A data generation method executed by one or more processors, the data generation method including
generating data in which group information on a result of grouping a plurality of users based on biological information of the plurality of users and a measurement condition of the biological information when the biological information is acquired are associated with each other.

[22]

A grouping model generation method executed by one or more processors, the grouping model generation method including,
by performing machine learning using teacher data in which biological information of a plurality of users and group information on a result of grouping the plurality of users based on the biological information of the plurality of users are associated with each other, generating a grouping model that outputs the group information in response to input of the biological information of the plurality of users.

[23]

A grouping model learning method executed by one or more processors, the grouping model learning method including
causing a grouping model generated by machine learning using teacher data in which biological information of a plurality of users and group information on a result of grouping the plurality of users based on the biological information of the plurality of users are associated with each other, to further learn teacher data in which the biological information, the group information, and
feedback data from the users are associated with each other.

[24]

An emotion estimation model generation method executed by one or more processors, the emotion estimation model generation method including,
by performing machine learning using teacher data in which human biological information and human emotions are associated with each other, generating an emotion estimation model that outputs emotion estimation data of a plurality of users used to group the plurality of users in response to input of biological information of the plurality of users.

[25]

A grouping user information generation method executed by one or more processors, the grouping user information generation method including:
aligning time axes of time-series data of biological information of a plurality of users; and outputting grouping user information used to group the plurality of users.

### INDUSTRIAL APPLICABILITY

The present technology can be used in matchmaking services that connect multiple people one-to-one, one-to-many, or many-to-many. Examples of fields targeted by the matchmaking services include romance, marriage, employment, and business. In the fields of romance and marriage, the present technology can be used in matchmaking between male and female. In the field of employment, the present technology can be used in matchmaking between companies looking for workers and job seekers looking for jobs. In the field of business, for example, the present technology can be used in matchmaking between doctors and patients in medical sites, matchmaking between sales representatives and customers, and matchmaking between teachers and students in various schools. In addition, for example, the present technology may be used for personnel changes within a company. Specifically, for a department being recruiting new members, the present technology can be used to make a match between existing department members and candidates for new members who wish to transfer to the department.

### REFERENCE SIGNS LIST

1 Information processing system
100 Information processing device
200 Biological information acquisition device
300 User terminal
400 Network

What is claimed is:

1. An information processing device comprising:
one or more processors; and
one or more memories storing instructions that, when executed by the one or more processors, cause the information processing device to execute operations,
wherein the operations include
grouping a plurality of users based on biological information of the plurality of users.

2. The information processing device according to claim 1, wherein
the grouping of the plurality of users based on the biological information of the plurality of users includes grouping the plurality of users based on
the biological information of the plurality of users, and
at least one of: image information of faces of the plurality of users as subjects, sound information including speech voices of the plurality of users, and location information of the plurality of users.

3. The information processing device according to claim 1, wherein
the one or more memories further store attribute information of the plurality of users, and
the grouping of the plurality of users based on the biological information of the plurality of users includes grouping the plurality of users based on
the biological information of the plurality of users and the attribute information of the plurality of users.

4. The information processing device according to claim 3, wherein
the one or more memories further stores grouping history information that is a result of grouping the plurality of users in the past based on the attribute information of the plurality of users, and
the grouping of the plurality of users based on the biological information of the plurality of users includes grouping the plurality of users based on
the biological information of the plurality of users, the attribute information of the plurality of users, and the grouping history information for each piece of the attribute information.

5. The information processing device according to claim 1, wherein the grouping of the plurality of users based on the biological information of the plurality of users includes grouping the plurality of users based on
emotion estimation data generated using the biological information of the plurality of users.

6. The information processing device according to claim 1, wherein the grouping of the plurality of users based on the biological information of the plurality of users includes grouping the plurality of users based on
emotion estimation data generated using the biological information of the plurality of users, and
at least one of: facial expression data generated using image information of faces of the plurality of users as subjects, speech data generated using sound information including speech voices of the plurality of users, and user-to-user distance data generated using location information of the plurality of users.

7. The information processing device according to claim 5, wherein
the emotion estimation data generated using the biological information of the plurality of users is generated by
inputting the biological information of the plurality of users into an emotion estimation model generated in advance by machine learning using teacher data in which human biological information and human emotions are associated with each other.

8. The information processing device according to claim 1, wherein the grouping of the plurality of users based on the biological information of the plurality of users includes
creating user pairs each composed of two users included in the plurality of users based on the biological information of the plurality of users.

9. The information processing device according to claim 1, wherein
the grouping of the plurality of users based on the biological information of the plurality of users includes
calculating a plurality of matchmaking indices for a user pair composed of two users included in the plurality of users;
calculating a distance between the users of the user pair based on a matchmaking index vector of each user in a matchmaking space composed of the plurality of matchmaking indices;
calculating a degree of matchmaking between the users of the user pair by using the distance between the users in the matchmaking space; and
grouping the plurality of users by using the degree of matchmaking, and
the calculating of the plurality of matchmaking indices includes
calculating the matchmaking indices based on the biological information of users of the user pair.

10. The information processing device according to claim 9, wherein the calculating of the matchmaking indices based on the biological information of the users of the user pair includes
performing in-phase/anti-phase analysis using time-series data of the biological information of the users of the user pair to calculate a first matchmaking index.

11. The information processing device according to claim 10, wherein the calculating of the first matchmaking index includes
calculating the first matchmaking index by Equation (I):
r=f(t)*g(t−τ) (I)
where when the users of the user pair are user A and user B, in Equation (I), r indicates the first matchmaking index, f(t) indicates time-series data of biological information of user A at a certain time, g(t) indicates time-series data of biological information of user B at a certain time, and τ indicates a deviation of timing of a physiological index with respect to an external stimulus that takes positive and negative values.

12. The information processing device according to claim 9, wherein the calculating of the matchmaking indices based on the biological information of the users of the user pair includes
performing calculation of an index of absolute difference value using time-series data of the biological information of the users of the user pair to calculate a second matchmaking index.

13. The information processing device according to claim 9, wherein the calculating of the degree of matchmaking between the users of the user pair by using the distance between the users in the matchmaking space includes
calculating the degree of matchmaking by Equation (III):
[Math. 1]
D_{w}(X_{personA},X_{personB})=\sqrt{Σⱼ₌₁^{N}wⱼ(X_{personA,j}−X_{personB,j})²} (III)
where the users of the user pair are user A and user B, in Equation (III), D_{w}(X_{personA}, X_{personB}) indicates the degree of matchmaking, N indicates the number of dimensions of the matchmaking space, X_{personA} indicates a matchmaking index vector of user A, X_{personB} is a matchmaking index vector of user B, j indicates an element number of the matchmaking index vector, and w (w=w₁, w₂, . . . , w_{N}) indicates a weight vector preset for each matchmaking index.

14. The information processing device according to claim 1, wherein the operations include performing
at least one of: processing for notifying the plurality of users of group information on a result of grouping the plurality of users and processing for prompting the plurality of users to act in a way that a physical distance between users in a same group becomes shorter.

15. The information processing device according to claim 1, wherein the operations include repeating:
grouping the plurality of users based on the biological information of the plurality of users; and
at least one of: processing for notifying the plurality of users of group information on a result of grouping the plurality of users and processing for prompting the plurality of users to act in a way that a physical distance between users in a same group becomes shorter.

16. The information processing device according to claim 1, wherein the operations include
receiving feedback data from one or more users.

17. The information processing device according to claim 1, wherein the grouping of the plurality of users based on the biological information of the plurality of users is executed by artificial intelligence.

18. The information processing device according to claim 5, wherein the emotion estimation data is generated by artificial intelligence.

19. The information processing device according to claim 1, wherein
the plurality of users are a plurality of users who each carry a biological information acquisition device, and
the biological information of the plurality of users is biological information of the plurality of users acquired by the biological information acquisition devices.

20. A data generation method executed by one or more processors, the data generation method comprising
generating group information on a result of grouping a plurality of users based on biological information of the plurality of users.

21. A data generation method executed by one or more processors, the data generation method comprising
generating data in which group information on a result of grouping a plurality of users based on biological information of the plurality of users and a measurement condition of the biological information when the biological information is acquired are associated with each other.

22. A grouping model generation method executed by one or more processors, the grouping model generation method comprising,
by performing machine learning using teacher data in which biological information of a plurality of users and group information on a result of grouping the plurality of users based on the biological information of the plurality of users are associated with each other, generating a grouping model that outputs the group information in response to input of the biological information of the plurality of users.

23. A grouping model learning method executed by one or more processors, the grouping model learning method comprising
causing a grouping model generated by machine learning using teacher data in which biological information of a plurality of users and group information on a result of grouping the plurality of users based on the biological information of the plurality of users are associated with each other,
to further learn teacher data in which the biological information, the group information, and feedback data from the users are associated with each other.

24. An emotion estimation model generation method executed by one or more processors, the emotion estimation model generation method comprising,
by performing machine learning using teacher data in which human biological information and human emotions are associated with each other, generating an emotion estimation model that outputs emotion estimation data of a plurality of users used to group the plurality of users in response to input of biological information of the plurality of users.

25. A grouping user information generation method executed by one or more processors, the grouping user information generation method comprising:
aligning time axes of time-series data of biological information of a plurality of users; and
outputting grouping user information used to group the plurality of users.
